(19) United States
(12) Patent Application Publication
(10) Pub. No.: US 2002/0003886 A1
(43) Pub. Date: Jan. 10, 2002

(54) Method and system for storing multiple media tracks in a single, multiply encrypted computer file

(76) Inventors: James C. Hillegass, Woodland, MN (US); Yaobing Deng, Minneapolis, MN (US); Mark Eastom, New Brighton, MN (US); Richard R. Fritz, Maple Grove, MN (US); John C. Gateley, Plymouth, MN (US); James A. Grinsfelder, St.Paul, MN (US); Stephen A. Grove, Minneapolis, MN (US); Eric Steven Hockett, Minneapolis, MN (US); Nikolay G. Sokratov, St.Louis Park, MN (US); James G. Swanson, St.Paul, MN (US); John S. Thomson, Afton, MN (US); Boris Mamedov, Hopkins, MN (US); James A. Nordgaard, St.Louis Park, MN (US); Paul E. Onnen, Issaquah, WA (US)

Correspondence Address: Beck & Tysver, P.L.L.C., Suite 100, 2900 Thomas Avenue South, Minneapolis, MN, 55416, US

(21) Appl. No.: 09/844,707

(22) Filed: Apr. 27, 2001

Related U.S. Application Data
(60) Provisional application No. 60/200,231, filed on Apr. 28, 2000.

(51) Int. Cl. H04L 9/00; G06F 17/60

(52) U.S. Cl. 380/282; 705/51; 713/193

(57) ABSTRACT

A method and system is presented for storing multiple tracks of music in a single structured storage file having multiple layers of organization. The top layer contains links to separate “folders” for each track, as well information associated with the collection of tracks as a whole. Inside each track folder is the digital data defining the music track, as well as information concerning that track. Audio/video information associated with the collection can be stored in the root file, while audio/video information associated with the track is stored in the track folder. A file header in the root directory contains a vendor ID and a product ID, which allows licensing software to examine the file and uniquely associate it with a particular license. Preview tracks contained in the track folders can be played if the no license exists. To prevent tampering with the product or vendor ID, the header file is encrypted with DES encryption using an encryption key common to all files. The actual music contained in each track is encrypted with an encryption key unique to that track.

### CROSS-REFERENCE TO RELATED APPLICATION

This application claims the benefit of U.S. Provisional Application Serial No. 60/200,231, filed on Apr. 28, 2000.

### TECHNICAL FIELD

The present invention relates to a method and system for storing single or multiple track media (audio or video) and related information in a single computer file.

### BACKGROUND OF THE INVENTION

The widespread demand for music and the growing availability of the Internet as a means of commerce have resulted in a multibillion-dollar industry for audio compact disks (“CDs”) sales via the Internet. In 1999, the sales of physical CDs via the Internet accounted for $890 million. It is anticipated that this will grow to $6.7 billion by the year 2003.

Along side this growth in the sales of physical CDs is the explosive growth in Internet music downloads. Audio compression technologies such as MP3 (MPEG Layer III) have allowed digital music to be stored at compression rates of 10 to 1 or better. This compression of digital format, along with the rise of the Internet and increasing bandwidth, have led to an explosion of downloadable digital music available over the Internet. Individual tracks of music can now be downloaded from the World Wide Web, sent via e-mail, or stored and downloaded via FTP sites and Usenet newsgroups.

One of the advantages of this new music distribution system is that it is possible to store non-musical information in the same computer file that stores the music track. For instance, the original MP3 specification allowed for the storage of the name of the artist and the song contained in the file, along with basic copyright information. Extensions to the MP3 file format, such as ID3 version one added the ability to record when and where the song was created. All of this additional information was essentially textual in nature, and was appended to the back of a normal MP3 file.

A demand exists to include non-textual information along with the music file. This demand was partially met by ID3 version two. This version of ID3, which was located at the beginning of the MP3 file, allowed for the creator of the file to include any type of digital information, such as a photograph, a web page, or even a computer software application. Of course, in order to work correctly, the software reading the file must be familiar with the ID3 version two standard and must be able to accommodate the type of data included. Assuming such compatibility, it is now possible to display images that are stored with the music file while the music file is playing.

Because of the way in which digital files can be easily duplicated and then distributed over the Internet, many parties have proposed incorporating a license scheme into standard music files. While there is no standard for placing a secure license scheme in the MP3 music format, several vendors have created new music types containing strict licensing standards. Once such format, created by Liquid Audio, Inc., allows a music track file to contain information about whether that music track had been properly licensed. The license itself is tied to a user's “passport,” which can only be transferred from one machine to another after a password is entered.

Unfortunately, none of these prior art file formats allow multiple tracks of music to be stored in a single physical file. Consequently, music must be downloaded and licensed on a track-by-track basis. Music companies have long known the advantages of selling music by the album, CD, or other such compilation, since consumers would be encouraged to purchase multiple tracks of music to obtain one or two desired songs. Meanwhile, users miss the advantages of hearing an entire grouping of music in the way originally intended by the artists. Finally, storage space is wasted when a user must download multiple independent tracks in order to recreate a CD of music, since common items such as jacket cover images, artist images, and credits must be recreated in each separate file. What is needed is a music file format that allows multiple tracks to coexist in the same file, with common information that is shared among the tracks stored only a single time within the file. What is further needed is a multi-track music file that selectively uses encryption to aid in the development of on-line music license schemes.

### SUMMARY OF THE INVENTION

The present invention meets these needs by providing a method and system for storing multiple tracks of music in a single physical file. In addition, the invention includes a method and system for associating text, images, and other content within the file with either a single music track or with all of the tracks contained within the file.

This is accomplished by defining a structured storage file containing multiple layers of organization. The top layer contains separate folders for each track, as well information associated with the compilation of all tracks.

The present invention also provides a secure link to licensing schemes. This link is the header file found within the top hierarchy layer of the music file. The header file contains a vendor ID and a product ID, which allows licensing software to examine the file and uniquely associate it with a particular license. If the user attempting to play the file has the correct license for the music present on the PC, the software will play the music found in the file. If no music license is present, then the software will refuse to play the full music tracks, but may still play any “preview” tracks that are included in the file and authorized without licensing.

The link to licensing schemes is secured through the use of selective encryption of the music file. To prevent tampering with the Product ID or Vendor ID, the header file is encrypted, specifically with DES encryption. All software programs that are designed to play the multi-track music files must be able to access the header, so the same DES key is used to encrypt every header used in the present invention.

In addition to securing the header, it is important that the actual music contained in each track be encrypted. In this case, however, it is inappropriate to use the same encryption key with every file of the present invention. Rather, in the preferred embodiment a separate encryption key is used for each compiled file. Ideally, this key is determined or identified by combining the product ID (and perhaps the vendor ID) found in the header of the multi-track file with a user ID associated with the user licensing the file.

While it is possible to encrypt the remaining information in the multi-track file, such as images and liner notes, it is not necessary to do so to maintain the integrity of the music license scheme. Thus, in the preferred embodiment, these additional pieces of information in the file remain unencrypted for easy and fast access during music playback.

### BRIEF DESCRIPTION OF THE DRAWINGS

FIG. 1 is a representational view of the multi-track file of the present invention in the context of creation, playback, and licensing.

FIG. 2 is a representational view of the root directory of the multi-track file of FIG. 1, showing the file header, track folders, and other content.

FIG. 3 is a detailed view of the file header shown in FIG. 2.

FIG. 4 is a detailed view of a track folder having a track header and other content.

FIG. 5 is a detailed view of the track header shown in FIG. 4.

### DETAILED DESCRIPTION OF THE INVENTION

1. Construction of File 100

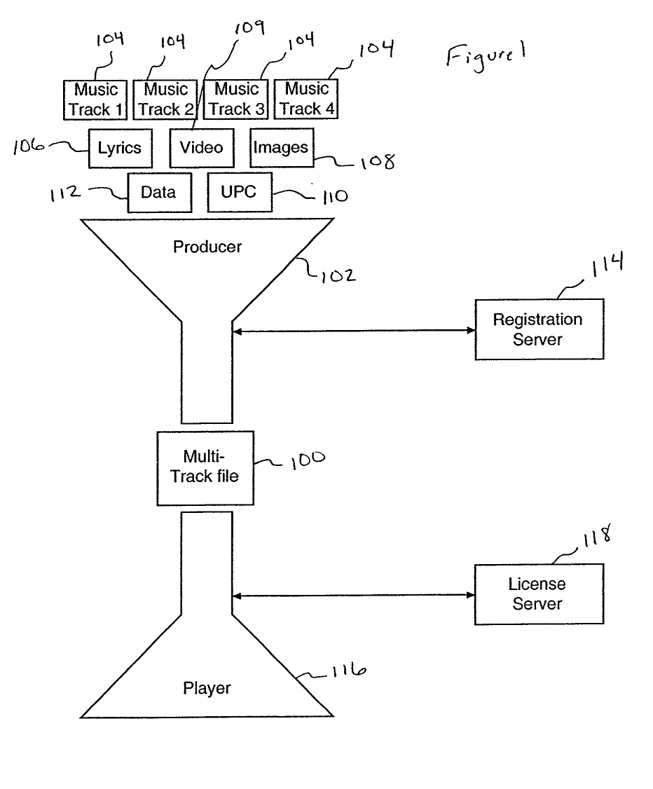

As shown in FIG. 1, the present invention provides a method and system for storing multiple tracks of data in a single computer file 100. The present invention is ideal for the creation of multi-track files containing musical data. As a result, the following description will be presented using musical data as the type of data contained in the present invention. However, it would be well within the scope of the present invention to apply to the present multi-track file structure to other types of audio-video materials that must be licensed, such as non-musical audio data, textual data, video data, graphical data, and audio-visual data.

The multi-track file 100 is created using a producer program 102, which is represented in FIG. 1 with a funnel. This representation illustrates that the producer 102 takes numerous and disparate sources of information and combines them into a single file 100. The file 100 is played with a player program 116, which is shown as an inverted funnel since this program 116 extracts the data from the multi-track file 100.

As illustrated in FIG. 1, producer 102 can accept as input multiple tracks of music 104, liner notes and/or lyrics 106, images 108, video data 109, UPC codes 110, and general information data 112. The information data 112 contains information about the music such as the name of the musician(s), the title of the music collection and individual tracks, etc.

The formats of the inputted materials 104-112 is immaterial to the present invention, as the formats can either be converted by the producer program 102 to a preferred format in the multi-track file, or the materials 104-112 can simply be stored in the file 100 in the original format. Typically, the data in the music tracks 104 is provided in either traditional CD audio format or a standard waveform format such as WAV, AIFF, or AU. If the tracks 104 are provided in one of the uncompressed formats, the producer 102 will compress the tracks 104 into a compressed format such as MP3. In the preferred embodiment, compression ranging from 32 to 320 kb/s per second is supported. Images can be stored in any of the well-known compressed file types such as JPEG or GIF. Video images 109 can also be added and stored in file 100 using a compressed format such as AVI (Video for Windows), MPEG, or Quicktime.

The producer program 102 is in communication with a registration server 114. This server 114 can be physically located on the same or nearby computer as that operating the producer 102. Ideally, however, the registration server 114 is remotely located, and in communication with multiple producer programs 102. The registration server 114 provides the producer 102 with a product identification code for the file 100. In addition, the registration server 114 provides the producer 102 with an encryption key to be used for encrypting musical data 104. Both the product ID and the encryption key should be unique to the file 100 being created. Alternatively, vendor identification can be placed in the file 100, and the combination of the vendor identification and the product ID can uniquely identify a file 100. At this point, it is also possible to add security features such as watermarking technology to the file in order to add another level of protection to the file.

Once the file 100 is created, the content within it can be presented to end users through player software 116. Preferably, the player software 116 is capable of playing the musical tracks 104 to end users, while also allowing users access to the lyrics 106, images 108, and general information data 112. A sophisticated player 116 would also be able to take UPC code 110 and electronically search various audio/video Internet-based retailers for the availability and price of physical copies (such as a CD) of the music collection in file 100.

In the preferred embodiment of the present invention, player 116 offers only limited access to the content of file 100 until the user licenses the file 100. When the user desires complete access, the player 116 contacts a license server 118, which ideally is physically distant from the player 116 and is accessed through a computer network such as the Internet. The license server 118 is either the same as the registration server 114, or can receive information (such as the encryption key associated with a product ID) from the registration server 114.

The license server 118 receives from player 116 the product ID originally created by the registration server 114, and returns some kind of license that allows the player 116 to decrypt the music in file 100. This license either contains the key used for decryption, or provides the player 116 with sufficient information that the key can be generated.

2. Root Level

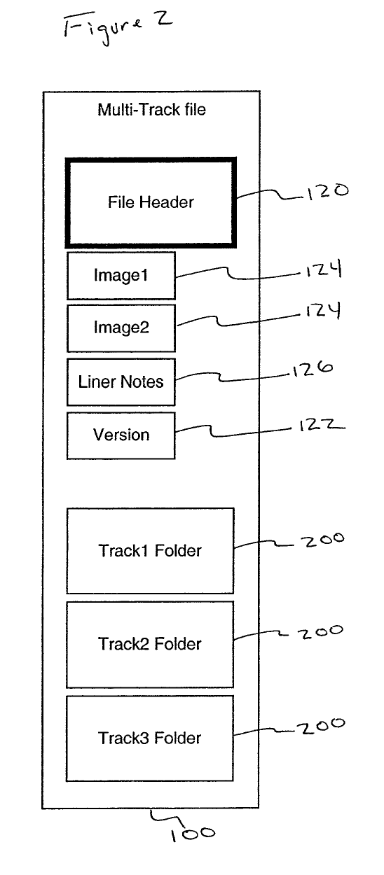

The multi-track file 100 is shown in more detail in FIG. 2. The file 100 is a type of structured storage file, such as the structured format specified by Microsoft Corporation (of Redmond, Wash.) in its Object Linking and Embedding (“OLE”) system. Structured storage files allow data to be compartmentalized and stored in a hierarchical structure using directories or folders, just like files in a hard drive. The items shown in FIG. 2 are those items that are found at the root level of the file 100. In the Figures, thick bold lines indicate encryption, while thinner lines indicate that information is not encrypted.

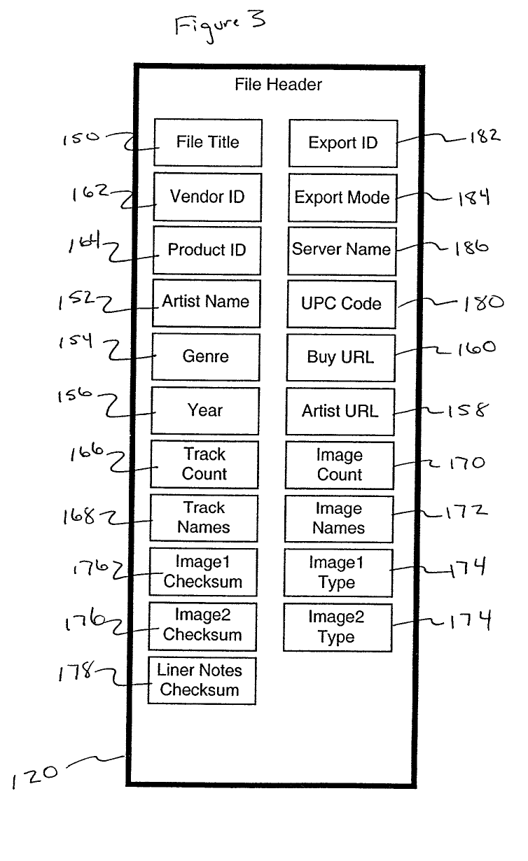

Conceptually, the multi-track file 100 is structured similar to an album or CD containing music, with some information relating to the CD as a whole, and some information relating to each of the tracks 104 on the CD. As a result, the file 100 must contain a file header 120, which contains information about all of the tracks 104 in file 100 as a whole, i.e., “meta-data” about the file 100. The file header 120, which is described in more detail below in connection with FIG. 3, is where the CD title, artist name, and product identification are kept.

In addition to the file header 120, the file 100 must also contain a version indicator 122. This indicator 122 lets player programs 116 that examine this file know what version of the present invention was used to create the file 100. While this information could easily be stored in the file header 120, it is maintained outside the header 120 to allow the header 120 to be encrypted without encrypting the version information 122.

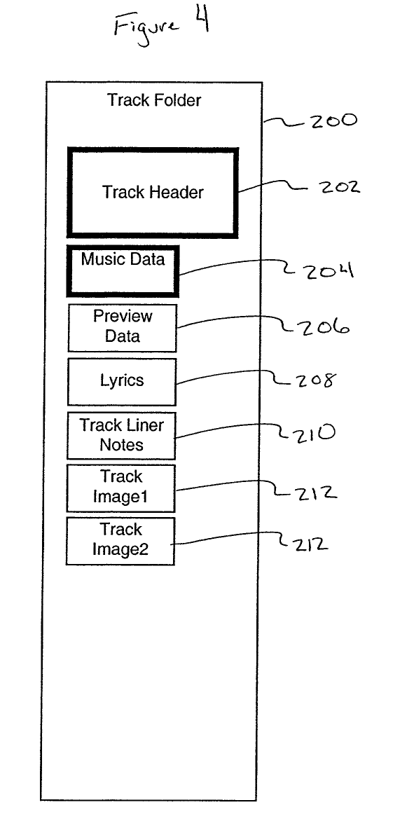

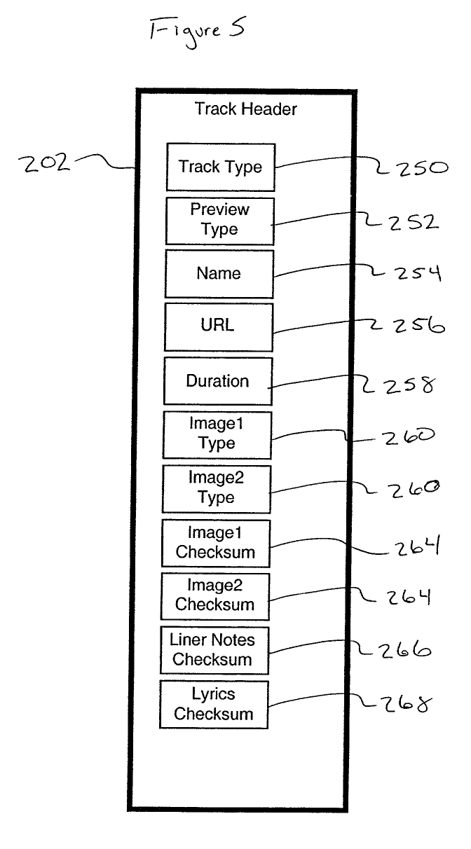

All music in the file 100 is contained in one or more track folders 200. Although only one track folder 200 is required to exist in the present invention, it is preferable to have multiple track folders 200 in a single file 100. Three track folders 200 are shown in FIG. 2. In addition to the actual music data for each track, the track folders 200 also contain information that is relevant only to a particular track, such as track title and lyrics. The track folders 200 are discussed in more detail below in connection with FIGS. 4 and 5.

While not required, the multi-track file 100 will often also contain at least one image file 124. These images 124 can then be displayed to the user while reviewing or playing music from the multi-track file 100. Image files 124 that are stored at this level in the file 100 are associated with the whole CD. If it is desired to associate an image 108 with only a singe track of music, the image file 124 should be stored in the appropriate track folder 200, as described below. Although not shown in FIG. 2, it is also possible to have video 109 and other types of data associated with the whole file 100 stored on the root directory.

It may also be desirable to have liner notes 126 or other textual information associated with the entire CD. Such notes 126 could describe the artist, the music in the file 100, or any other information desired by the creator of the file 100. In the preferred embodiment, liner notes 126 are stored in rich text format to allow formatting of the text. Any other format for such information would be within the scope of the present invention.

3. File Header 120

FIG. 3 shows the information that is stored in the file header 120. As explained above, the file header 120 contains basic information about the collection of music contained in file 120. Included in such basic information are the title of the collection 150, the artist's name 152, the genre of the music 154, and the year(s) the music was recorded 156. The creator of the music may also wish to include links to World Wide Web sites describing the artist (artist URL 158) and where a physical copy of the music CD can be purchased (buy URL 160).

The file header 120 also contains the vendor ID 162 and the product ID 164. As explained above, the product ID 164, either alone or in combination with the vendor ID 162, will uniquely identify the file 100 to the license server 118. The vendor ID 162 is also used to inform the license server 118 of the vendor who should be compensated for the granting of a license. Alternatively, the product ID 164 can be uniquely associated with a particular vendor 162, and the vendor information can be stored in a database on the license server 118 that associates a product ID 164 with a particular vendor. In this case, it would not be necessary to include the vendor ID 162 in the file header 120.

The track count 166 within file header 120 identifies the number of tracks that are found within the file. The track names 168 identify the names of all of the tracks 104 in file 100. Since multiple names need to be stored in the track names 168 area of the header, it is preferred to format the track names 168 area as a list type data structure. In this way, multiple names can exist in the track names area 168 of the file header 120.

Similarly, file header 120 also contains image count 170 and image names 172, which contain the number and names of images 124 stored at the root level of multi-track file 100. In addition to number and names of images 124, the file header 120 also contains the type 174 and the checksum 176 for each image 124 at the root level of file 100. The type 174 value indicates which type of formatting was used to encode the image 124 into digital format. The checksum values 176 ensure that the images 124 stored in the file 100 have not been altered since the file was created. In FIG. 3, separate areas 174, 176 are shown in header 120 for each image 124. Alternatively, it would be possible to utilize a list type data structure for these values, such as that used for track names 168 and image names 172.

File header 120 also contains a liner notes checksum value 178 and the UPC Code 180. The checksum value 178 helps ensure that the liner notes 126, stored unencrypted at the root level of file 100, have not been altered since creation. The UPC Code 180 can be used to help search the Internet or a similar network for parties who sell the physical CD represented by file 100. By searching on the UPC Code 180, it is possible to avoid the ambiguities involved in searching by artist 152 or CD title 150.

Finally, the file header 120 contains an export ID 182, an export mode indicator 184, and the server name 186. The export ID 182 and export mode indicator 184 serve to signal the player whether to allow “export” to standard audio CD or portable device, and if so what price, if any, to charge the user. If export were allowed only after obtaining an additional license, the player software 116 would request a license from the license server 118 using the export ID 182 in place of the product ID 164. The server name field 186 provides the name of the registration server 114 that created the product ID 164 and the encryption code used by the producer 102 to create the multi-track file 100.

4. Track Folder 200

The track folder 200 is shown in FIG. 4. As explained above in connection with FIG. 2, one track folder 200 exists for each music track 104 found in file 100.

The most important elements of the track folder 200 are the track header 202 and the music data 204. The track header 202 is similar to the file header 120, in that it is an encrypted data segment that contains basic information about the track. The track header 202 is encrypted to protect the integrity of the information it contains. The decryption key used to decrypt the track header 202 is the same for every multi-track file 100, and is stored in the player 116. Typically, this decryption key is also the same key used to decrypt file header 120. The contents of the track header 202 are explained in detail below in connection with FIG. 5.

The music data 204 contains the actual information needed to play music for the track 104. This information is preferably compressed in any of the standard compression technologies, such as the MP3 format. The information is encrypted using the encryption key that was received from the registration server 114 by the producer 102. This decryption key is unique to the individual file 100, but is shared between all of the music data 204 storing the tracks 104. Consequently, it would be impractical and counter-productive to basic licensing schemes for the player 116 to store all of the decryption keys used for all of the possible multi-track files 100. As a result, although the player 116 has access to all of the rest of the data in the file 100, the actual data containing the music tracks 104 is encrypted and kept from the player until the decryption key is made available to it. This is typically accomplished through interaction with License Server 118, as described above in connection with FIG. 1.

The track folder 200 also contains preview data 206, which is typically unencrypted music data. Preview data 206 is generally a subset of the data contained in music data 204, and is made available to users of the player program 116 that have not obtained a full license to the multi-track file 100.

Textual data is also saved in track folder 200, such as lyrics 208 and track liner notes 210 that are specific for the track 104. Track liner notes 210 can exist in some track folders 200 but not in others. Where track liner notes 210 do not exist, the file wide liner notes 126 are assumed to be applicable. In this way, the liner notes 126 stored at the root level of file 100 can serve as the default liner notes, which are overridden by track liner notes 210 for a specific track.

Track folder 200 can also contain one or more track images 212 that are specific for the track 104. Much like the track liner notes 210, track images 212 can be stored in some track folders 200 but not in others, allowing the main images 124 stored at the root level to serve as default images for tracks without track images 212.

Note that while the preferred embodiment of the player 116 utilizes the track specific images 212 and liner notes 210 to override the general images 124 and liner notes 126, this is not the only available option within the scope of the present invention. Alternatively, the player 116 could make the general liner notes 126 and the track specific liner notes 210 available at the same time. Similarly, player 116 could display both the file wide images 124 and the track images 212 simultaneous or consecutively during playback of a specific track 104.

5. Track Header 202

The track header 202 is shown in detail in FIG. 5. Since it is possible to store track music data 204 and preview data 206 in different types of compressed music formats, the track format type 250 and the preview format type 252 are stored in track header 202. Possible types that could be indicated in these locations 250, 252 include MP3, MOD, AIFF, and WAV. The track header 202 also contains the name 254 of the track 104, a URL 256 that can be associated with a track 104, and the duration 258 of the track.

As was the case with images 124 stored in the root area of multi-track files 100, it is necessary to store the image type 260 of the track images 212 stored in each track folder 200. It is also useful to maintain a separate checksum 264 for each image, to ensure that the images 212 in the track folder 200 have not been modified since creation. Finally, the track header 202 also contains checksums 266, 268 to verify the integrity of the track liner notes 210 and the lyrics 208, respectively.

6. Encryption and Distribution of File 100

The multi-track file 100 of the present invention uses partial encryption using different encryption keys to increase the usefulness of the file 100 in license protection schemes. Because of the unique structure of the present invention file 100, it is possible to develop a licensing scheme that does not require any alteration of the files before, during, or after licensing.

For instance, a licensing scheme could be developed in which the player 116 would allow access only to the preview data 206 for each track 104 before licensing. The player 116 would also allow an unlicensed user to view basic information about the CD contained in the file 100, such as the title 150, artist 152, and images 124, 212. In fact, the user could even access purchase information obtained by the player 116 searching retail web sites using the UPC code.

When the user wishes to obtain a license to the file, the player 116 would contact the license server 118 to obtain the license. The license could be physically embodied as a computer file or as an entry into a registration database saved by the player 116 or the operating system on which the player 116 is operating. The player 116 would automatically search for an appropriate license whenever a multi-track file 100 is opened. The player could verify that the license on the computer is appropriate for the file 100 by comparing the product ID 164 in the file header 120 to a product ID found in the license. In addition, or alternatively, since the decryption code needed to decrypt the music data 204 is unique to the file 100, only a license for the correct file 100 will decrypt the file 100.

Because the existence or non-existence of a license does not alter the multi-track file 100, the file 100 can be distributed freely. Other licensing schemes require that the licensed file be distributed concurrently with the licensing of the file, because the licensed is embedded directly into the file itself. These schemes do not allow the files to be distributed on numerous servers, nor can an already licensed product be effectively distributed to new, unlicensed users.

It is possible to tie a license received by a player 116 to a specific user or computer on which the player 116 is operating. This is accomplished by sending user or computer specific information to the license server 118, which would allow the license server 118 to incorporate such information into the license sent back to the player 116. The player 116 would then examine that information in the license to ensure that the license is appropriate for this user or computer.

The player 116 can be a specially configured application designed solely for playing multi-track files 100 of the present invention. Alternatively, the player 116 can be a general music application that accepts plug-ins, where a plug-in is designed to handle licensing and decoding of the encrypted elements of the multi-track files 100.

The invention is not to be taken as limited to all of the details express above, as modifications and variations may be made without departing from the spirit or scope of the invention. For instance, although the preferred embodiment encrypts the file header 120 and the track header 202, it would be within the scope of the present invention to leave these unencrypted. Also, although this encryption uses a different key than the encryption used for music data 204, it would be possible to use the same encryption key.

In addition, while the images 124, 212 are not encrypted in the preferred embodiment, it would be well within the scope of the present invention to encrypt the images 124, 212. Finally, while FIGS. 2-5 show only one type of complex digital data (images 108) as included in the file 100, it would be well within the scope of the present invention to include video data 109, or any other type of digital data, including database or word processing files. Many possible combinations of features and elements are possible within the scope of the present invention, and therefore the scope thereof should be limited only by the following claims.

What is claimed is:

1. A method for storing multiple tracks of media data in a structured secured file comprising:
a) storing in the file a file header containing meta-data concerning the file;
b) creating at least two track folders in the file, with one track folder for each track stored in the file, each track folder containing
i) a track header containing meta-data concerning the track; and
ii) the media data defining the track stored in an encrypted format.

2. The method of claim 1, wherein the media data is chosen from at least one of the following types: music data, non-musical audio data, textual data, video data, graphical data, and audio-visual data.

3. The method of claim 1, further comprising:
c) encrypting the file header using a first encryption key; and
d) encrypting the media data with a second encryption key.

4. The method of claim 3, further comprising:
e) encrypting the track header using the first encryption key.

5. The method of claim 3, further comprising:
e) storing the first encryption key in every software package capable of playing the structured secured file; and
f) storing the second encryption key in a product license that is distributed to a possessor of the structured secured file only after the possessor has requested the product license to the structured secured file.

6. The method of claim 5, wherein the product license is not distributed until the possessor of the structured secured file has paid a license fee for the product license.

7. The method of claim 6, further comprising:
g) storing unencrypted media data in the file; and
h) allowing access to the unencrypted media data when the possessor of the file does not have the product license.

8. The method of claim 3, further comprising:
e) storing in the file unencrypted file-related audio-visual material relating to the media data, and
f) storing a first checksum value relating to the file-related audio-visual material in the encrypted file header, the first checksum value serving to verify that the file-related audio-visual material has not been altered since the file was created.

9. The method of claim 8, further comprising:
g) storing unencrypted track-related audio-visual material relating to a specific media track in the track folder containing the specific media track;
h) storing a second checksum value relating to the track-related audio-visual material in the track folder containing the specific media track; and
i) encrypting the track header using the first encryption key.

10. A multi-track media file comprising:
a) a file header containing information relevant to the entire media file;
b) at least two tracks of media data; and
c) one track header for each track, each track header containing information relevant only to one track.

11. The multi-track media file of claim 10, wherein the media data is chosen from at least one of the following types: music data, non-musical audio data, textual data, video data, graphical data, and audio-visual data.

12. The multi-track media file of claim 10, wherein the file header is encrypted with a first encryption key and the tracks of media data are encrypted with a second encryption key.

13. The multi-track media file of claim 12, wherein the track headers are encrypted with the first encryption key.

14. The multi-track media file of claim 12, further comprising:
d) audio-visual material relevant to the complete media file; and
e) A checksum value verifying the integrity of the audio-visual material, the checksum value being located within the encrypted file header.

15. The multi-track media file of claim 10, further comprising:
d) one track folder for each track, with each track folder containing exactly one track of media data and the associated track header.

16. The multi-track media file of claim 15, wherein the file header is encrypted with a first encryption key and the tracks of media data are encrypted with a second encryption key.

17. The multi-track media file of claim 16, wherein the track headers are encrypted with the first encryption key.

18. The multi-track media file of claim 17, further comprising:
e) audio-visual material relevant to a particular track stored unencrypted in the track folder that contains the particular track; and
f) a checksum value verifying the integrity of the audio-visual material, the checksum value being located within the encrypted track header associated with the particular track.

19. The multi-track media file of claim 18, further comprising:
g) file liner notes applicable to the complete media file; and
h) track liner notes applicable to a selected track stored unencrypted in the track folder containing the selected track.

20. The multi-track media file of claim 19, wherein the file liner notes have an associated checksum stored in the file header and the track liner notes also have an associated checksum stored in the track folder associated with the selected track.

21. A multi-track music file comprising:
a) a file header encrypted using a first encryption key, the encrypted file header containing
i) a file identifier, and
ii) other data relevant to the complete music file;
b) file audio-visual material related to the complete music file;
c) at least two track folders, with each track folder containing
i) a single track of music data encrypted using a second encryption key,
ii) a track header containing data relevant to the track of music data, and
iii) track audio-visual material related to the track.

22. The multi-track music file of claim 21, wherein the track audio-visual material and the file audio-visual material include data of at least one of the following types: textual data, audio data, graphical images, and video images.

23. The multi-track music file of claim 21, wherein the track header is encrypted using the first encryption key.

24. The multi-track music file of claim 21, wherein the file identifier is capable of uniquely identifying the multi-track music file to a licensing system.
